(19) United States
(12) Patent Application Publication
(10) Pub. No.: US 2026/0236185 A1
(43) Pub. Date: Aug. 13, 2026

(54) DETECTING UNEXPECTED MEMORY READ

(71) Applicant: QUALCOMM Incorporated, San Diego, CA (US)

(72) Inventors: Aiqun YU, Shanghai (CN); Yiwei HUANG, Shanghai (CN); Zhenhua HUANG, Shanghai (CN)

(21) Appl. No.: 19/161,182

(22) PCT Filed: Mar. 14, 2023
(86) PCT No.: PCT/CN2023/081275

§ 371 Date: Aug. 29, 2025

(51) Int. Cl. G06F 3/06

(52) U.S. Cl. CPC G06F 3/0655; G06F 3/0604; G06F 3/0653; G06F 3/0679

(57) ABSTRACT

Various embodiments include methods implemented in a processor of a computing device for detecting an unexpected memory read. Embodiments may include clearing a memory access flag following a first duration in which an application is configured for access to a memory of the computing device, and determining whether the memory access flag is set following clearing the memory access flag. Embodiments may include receiving a call to clear the memory access flag from the application following the first duration, in which clearing the memory access flag may include clearing the memory access flag in response to receiving the call to clear the memory access flag. Embodiments may include setting the memory access flag in response to a memory access following clearing the memory access flag. Embodiments may include the memory access flag being a stage 2 page table access flag.

### BACKGROUND

Applications running on computing devices can have dedicated memory space, such as in random access memory or cache memory, allocated for critical application information. The dedicated memory space is intended for access by the application and not by other applications or tasks unrelated to the application. Some operating systems have revealed kernel source code for which a malevolent actor can build kernel space code with kernel address space privileges that enable the malevolent actor to access the application's dedicated memory.

### SUMMARY

Various aspects include apparatuses and methods for implementing detecting an unexpected memory read. Various aspects may include clearing a memory access flag following a first duration in which an application is configured for access to a memory of the computing device, and determining whether the memory access flag is set following clearing the memory access flag.

Some aspects may further include receiving a call to clear the memory access flag from the application following the first duration, in which clearing the memory access flag includes clearing the memory access flag in response to receiving the call to clear the memory access flag. Some aspects may further include setting the memory access flag in response to a memory access following clearing the memory access flag.

In some aspects, determining whether the memory access flag is set following clearing the memory access flag may include determining whether the memory access flag is set during a second duration following the first duration. In some aspects, determining whether the memory access flag is set following clearing the memory access flag may include determining whether the memory access flag is set during a second duration preceding a successive first duration.

Some aspects may further include generating encrypted data of the memory in response to determining that the memory access flag is set following clearing the memory access flag; and sending the encrypted data of the memory to a remote server. In some aspects, generating encrypted data of the memory may include generating encrypted data of the memory at a secure execution environment of the processor using an encryption key provided by the application.

In some aspects the memory access flag is a stage 2 page table access flag.

Further aspects include computing devices including an inline cryptographic device configured to perform operations of any of the methods summarized above.

Further aspects include computing devices having means for performing any of the functions of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a component block diagram illustrating an example processor suitable for implementing various embodiments.

FIGS. 3A and 3B are component block and flow diagrams illustrating an example of detecting unexpected memory read for implementing various embodiments.

FIG. 4 is a process flow diagram illustrating a method of detecting unexpected memory read according to some embodiments.

FIG. 5 is a component block diagram illustrating an example mobile computing device suitable for implementing various embodiments.

FIG. 6 is a component block diagram illustrating an example mobile computing device suitable for implementing various embodiments.

FIG. 7 is a component block diagram illustrating an example server suitable for implementing various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods, and computing devices implementing such methods, for implementing detecting unexpected memory reads. Embodiments may include clearing a memory access flag, set for a memory access by an application of a dedicated memory space for the application. Some embodiments may include checking whether the memory access flag is set after clearing the memory access flag. The check of the memory access flag resulting in finding that the memory access flag is set may be indicative of an unexpected memory read. In some embodiments, in response to finding that the memory access flag is set, a copy of the application data of the dedicated memory space may be encrypted and sent for analysis for determining whether the finding that the memory access flag is set is a result of an unexpected memory read. In some embodiments, the application data of the dedicated memory space may include the state of the memory access flag.

The terms “computing device” and “mobile device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

Applications running on computing devices can have dedicated memory space, such as in random access memory or cache memory, allocated for critical application information. The dedicated memory space is intended for access by the application and not by other applications or tasks unrelated to the application. Some operating systems have revealed kernel source code for which a malevolent actor can build kernel space code with kernel address space privileges that enable the malevolent actor to access the application's dedicated memory.

For a non-limiting example, a game application running on a computing device using an open source based operating system, such as a Linux based operating system, can store critical information at the game application's dedicated memory space. A malevolent actor can use kernel space code, with kernel address space privileges, such as exception level 1 (EL1) address space privileges, built to access the game application's dedicated memory space to read the game application's critical information. The malevolent actor can use the critical information to gain an advantage in playing the game, such as by using an information overlay in a game display that is unavailable to other players of the game.

Application vendors want to be able to detect and/or prevent unexpected memory read at applications' dedicated memory spaces using methods or modules other than the applications, such as by other kernel space code, to prevent unauthorized use of the applications' critical information. However, the application vendors cannot prevent malevolent actors from leveraging source revealed operating system capabilities/vulnerabilities or rooting of the operating systems on computing devices enabling access to the applications' dedicated memory spaces. A source revealed operating system may be any operating system for which source code may be intentionally revealed, such as an open source based operating system, and/or unintentionally revealed, such as a closed source operating system for which source code may be leaked by accident and/or malevolent act.

Current approaches to prevent use of applications' critical information include boot image verification to ensure that boot images are verified by an original equipment manufacturer (OEM). Such approaches prevent use of the applications for any changes to the boot images, even if unrelated to the applications. Application developers do not want to prevent users from using applications for reasons unrelated to unexpected memory reads of the applications' critical information.

Various embodiments address and overcome the foregoing problems of use of applications' critical information by providing a detection scheme for unexpected memory reads made at the applications' dedicated memory space. The detection scheme of various embodiments may provide indications of potential unexpected memory reads that application vendors may use to determine whether the memory reads are by malevolent actors, enabling application vendors to take actions to prevent the use of applications' critical information by the malevolent actors. For example, application vendors may suspend user access to the applications, such as by freezing a user account server logging of the application, in response to determining that the memory reads are by malevolent actors. The detection scheme may provide application specific detection, avoiding overbroadly preventing users from using the applications for reasons unrelated to unexpected memory reads of the applications' critical information.

In response to an application's dedicated memory space being accessed, a memory access flag may be set. For example, the memory access flag may be in a page table configured for translation of virtual addresses of the application's dedicated memory space, such as a stage 2 page table access flag in a stage 2 page table or a stage 1 page table access flag in a stage 1 page table. The application may issue a call to a hypervisor to clear the memory access flag. In response to the call to clear the memory access flag, the hypervisor may clear the memory access flag. For example, the hypervisor may clear the memory access flag in the page table. The application may issue a call to the hypervisor to check the memory access flag. In response to the call to check the memory access flag, the hypervisor may check the memory access flag. For example, the hypervisor may check the memory access flag in the page table.

The application may be configured to access the application's dedicated memory space during an access duration, which may occur periodically. The application's call to clear the memory access flag may occur outside of the access duration and may trigger the hypervisor to clear the memory access flag outside of the access duration. Between instances of the access duration, any access to the application's dedicated memory space may trigger setting the memory access flag. The application may be configured to issue the call to check the memory access flag of the application's dedicated memory space during a check duration. In some examples, the check duration may occur a wait duration following and/or preceding an access duration. In some examples, the check duration may occur a wait duration following a prior check duration. The check duration may occur independent of timing of an access duration.

In some embodiments, the hypervisor may provide a return result of the check of the memory access flag to the application indicating to the application whether the memory access flag is set. The application may interpret the return result from the hypervisor and determine whether the memory access flag is set. In some embodiments, in response to the call to check the memory access flag, the hypervisor may determine, from checking the memory access flag, whether the memory access flag is set. In response to determining that the memory access flag is set, the hypervisor may provide a return result to the application indicating to the application that the memory access flag is set.

In response to interpreting that the memory flag being set, the application may issue a call to a secure execution environment to generate and encrypted data including the data of the application's dedicated memory space. The data of the application's dedicated memory space may include the state of the memory access flag for the application's dedicated memory space. The secure execution environment may be an execution environment of a processor having access controls limiting which processor-executable code instructions and data the secure execution environment may use. The access controls reduce the likelihood that a malicious actor can infiltrate the secure execution environment and/or access processor-executable code instructions and data used by the secure execution environment. The encrypted data may include other data, such as a timestamp, user information, computing device information, expected memory access state, etc.

The secure execution environment may be configured with processor-executable code instructions to generate the encrypted data and send the encrypted data to a remote server. The remote server may be configured with processor-executable code instructions for analyzing whether the encrypted data indicates that the unexpected memory read is by a malevolent actor and whether to take action to prevent the use of applications' critical information from the application's dedicated memory space by the malevolent actor.

Having cleared the memory access flag outside of an access duration, the memory access flag for the application's dedicated memory space being set may indicate a memory access outside of the access duration. Any access to the application's dedicated memory space between instances of the access duration may be an unexpected memory read and may trigger setting the memory access flag. A result of checking the memory access flag during a check duration indicating that the memory access flag is set may indicate an unexpected memory read of the application's dedicated memory space. The result of checking the memory access flag indicating that the memory access flag is set may trigger the application to respond to the possibility of an unexpected memory access by triggering generation of encrypted data for evaluation by a remote server of whether an unexpected memory read occurred.

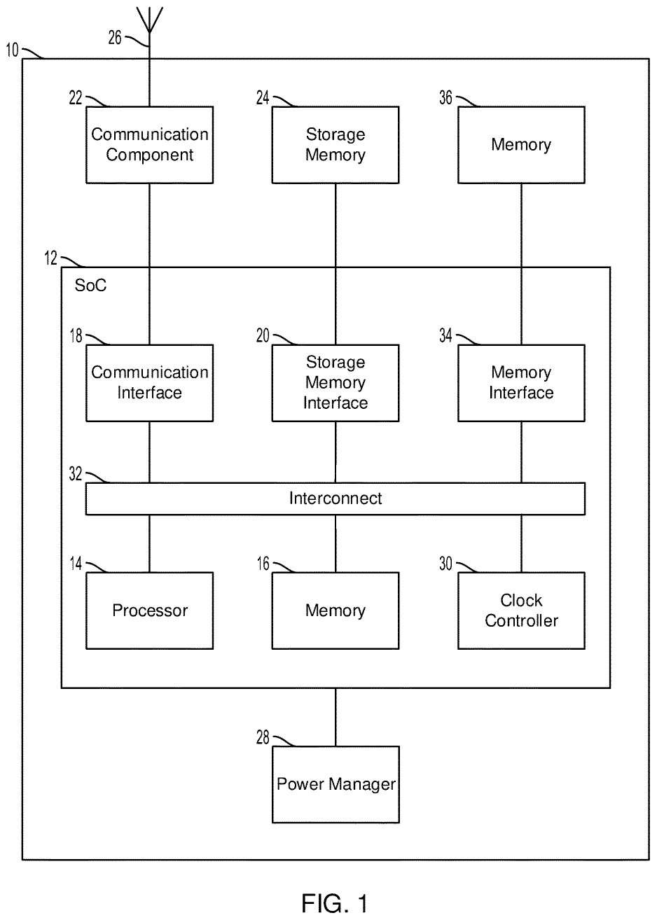

FIG. 1 illustrates a system including a computing device 10 suitable for use with various embodiments. The computing device 10 may include a system-on-chip (SoC) 12 with a processor 14, a memory 16, a memory interface 34, a communication interface 18, a storage memory interface 20, a clock controller 30, and an interconnect 32. The computing device 10 may further include a communication component 22, such as a wired or wireless modem, a storage memory 24, an antenna 26 for establishing a wireless communication link, a power manager 28, and a memory 36. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), a secure processing unit (SPU), neural network processing unit (NPU), a subsystem processor of specific components of the computing device, such as an image processor for a camera subsystem or a display processor for a display, an auxiliary processor, a single-core processor, a multicore processor, a controller, and a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processors 14. The computing device 10 may include more than one SoC 12, thereby increasing the number of processors 14 and processor cores. The computing device 10 may also include processors 14 that are not associated with an SoC 12. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The computing device 10 may include any number and combination of memories, such as the memory 16 integral to the SoC 12 and the memory 36 separate from the SoC 12. Any of the memories 16, 36 may be a volatile or non-volatile memory configured for storing data and processor-executable code for access by the processor 14. The computing device 10 and/or SoC 12 may include one or more memories 16, 36 configured for various purposes. One or more memories 16, 36 may include volatile memories such as random access memory (RAM) or main memory, including static RAM (SRAM), such as the memory 16, dynamic RAM (DRAM), such as the memory 36, or cache memory.

The memories 16, 36 may be configured to temporarily store a limited amount of data. For example, the data may be received from a data sensor or subsystem. As another example, the data may be data and/or processor-executable code instructions that are requested from a non-volatile memory 16, 24, 36 loaded to the memories 16, 36 from the non-volatile memory 16, 24, 36 in anticipation of future access based on a variety of factors. As another example, the data may be intermediary processing data and/or processor-executable code instructions produced by the processor 14 and temporarily stored for future quick access without being stored in non-volatile memory 16, 24, 36.

The memory interface 34 may work in unison with the memory 36 to enable the computing device 10 to store and retrieve data and processor-executable code on and from the memory 36. The memory interface 34 may control access to the storage memory 36 and allow the processor 14 to read data from and write data to the memory 36. In some embodiments, the memory interface 34 may include a memory management unit.

The storage memory interface 20 and the storage memory 24 may work in unison to allow the computing device 10 to store data and processor-executable code on a non-volatile storage medium, such as a nonvolatile memory device. The storage memory 24 may be configured much like an embodiment of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

The power manager 28 may be configured to control power states of one or more power rails (not shown) for power delivery to the components of the SoC 12. In some embodiments, the power manager 28 may be configured to control amounts of power provided to the components of the SoC 12. For example, the power manager 28 may be configured to control connections between components of the SoC 12 and the power rails. As another example, the power manager 28 may be configured to control amounts of power on the power rails connected to the components of the SoC 12. The power manager 28 may be configured as a power management integrated circuit (power management ICs or PMIC).

A clock controller 30 may be configured to control clock signals transmitted to the components of the SoC 12. For example, the clock controller 30 may gate a component of the SoC 12 by disconnecting the component of the SoC 12 from a clock signal and may ungate the component of the SoC 12 by connecting the component of the SoC 12 to the clock signal.

The interconnect 32 may be a communication fabric, such as a communication bus, configured to communicatively connect the components of the SoC 12. The interconnect 32 may transmit signals between the components of the SoC 12. In some embodiments, the interconnect 32 may be configured to control signals between the components of the SoC 12 by controlling timing and/or transmission paths of the signals.

Some or all of the components of the computing device 10 and/or the SoC 12 may be arranged differently and/or combined while still serving the functions of the various embodiments. The computing device 10 may not be limited to one of each of the components, and multiple instances of each component may be included in various configurations of the computing device 10.

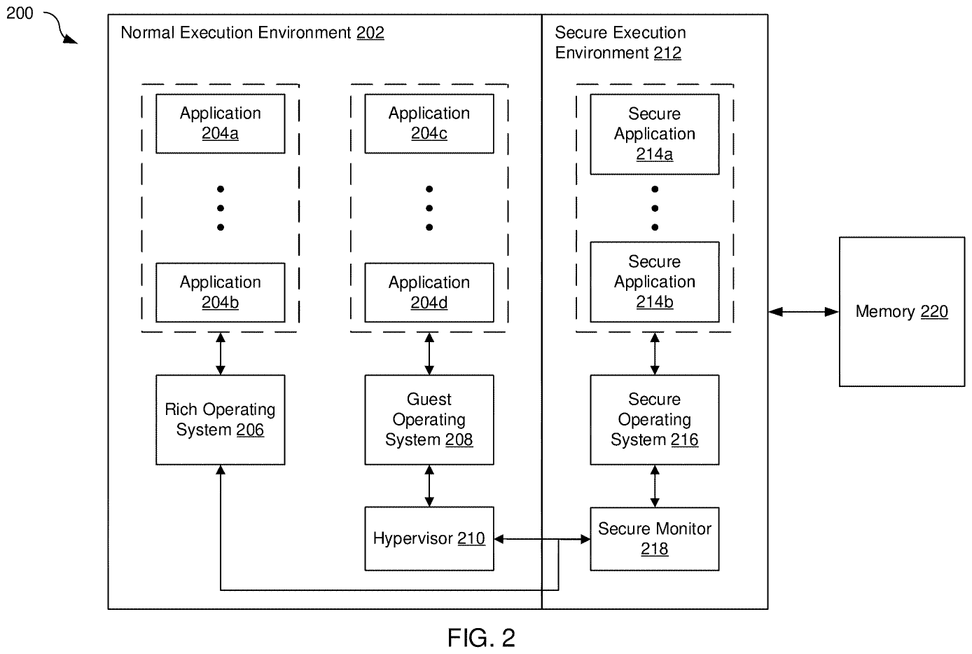

FIG. 2 illustrates an example of a processor suitable for implementing various embodiments. With reference to FIGS. 1 and 2, the processor 200 (e.g., processor 14 in FIG. 1) may include a normal execution environment 202 and a secure execution environment (or trusted execution environment) 212 (e.g., ARM TrustZone, AMD Secure Technology, IBM Secure Service Container, Intel Trusted Execution Technology, etc.). In some embodiments, the processor 200 may include a memory 200 (e.g., memory 16 in FIG. 1), such as cache memory. In some embodiments, the processor 200 may be connected to the memory 200 (e.g., memory 16, memory 36 in FIG. 1), such as RAM.

The normal execution environment 202 may be configured with processor-executable instructions for implementing various functions, such as any number and combination of applications 204a, 204b, 204c, 204d (e.g., game applications, productivity applications, entertainment applications, web browser applications, communication applications, etc.), a rich operating system 206 (or host operating system; e.g., Android, Linux, etc.), any number of guest operating systems 208, and/or any number of hypervisors (or virtual machine managers) 210. The secure execution environment 212 may be configured with processor-executable instructions for implementing various functions, such as any number and combination of secure applications (or trusted applications) 214a. 214b, a secure operating system (or trusted operating system) 216, and/or a secure monitor 218. The software of the normal execution environment 202, including the applications 204a-204d, the rich operating system 202, the guest operating system 208, and/or the hypervisor 210, and the software of the secure execution environment 212, including the secure application 214a, 214b, the secure operating system 216, and/or the secure monitor 218, may include processor-executable instructions to implement various functions.

In the normal execution environment 202, the rich operating system 206 may run any number and combination of applications 204a, 204b. The rich operating system 206 may be configured allocate dedicated memory space to one or more of the applications 204a, 204b in the memory 200 and implementing memory access to the dedicated memory space for the respective applications 204a, 204b. Allocating and implementing access to the dedicated memory spaces may be implemented by the rich operating system 206 via hardware (not shown) of the processor configured for managing communications with the memory 200, such as memory management unit (e.g., memory interface 34 in FIG. 1). The rich operating system 206 may also be configured to manage communications between the applications 204a, 204b and the secure execution environment 212.

The guest operating system 208 may be configured to allocate dedicated memory space to one or more of the applications 204c, 204d in the memory 200 and implementing memory access to the dedicated memory space for the respective applications 204c, 204d. Allocating and implementing access to the dedicated memory spaces may be implemented by the guest operating system 208 via the hardware of the processor configured for managing communications with the memory 200, such the memory management unit. The guest operating system 208 may also be configured to manage communications between the applications 204c, 204d and the secure execution environment 212. The hypervisor 210 may manage communications between the guest operating system 208 and/or the applications 204c, 204d and the hardware of the processor 200, including for communication with the memory 200 and/or the secure execution environment 212.

In the secure execution environment 212, the secure operating system 216 may be configured to manage communications between one or more of the secure applications 214a, 214b and the one or more of the applications 204a-204d. For example, the secure operating system 208 may manage data and/or instructions from the applications 204a-204d at the normal execution environment 202 to the secure applications 214a, 204b at the secure execution environment 212. The secure operating system 216 may manage implementing memory access to the memory 200 for the secure applications 214a, 214b. Implementing access to the dedicated memory spaces may be implemented by the secure operating system 216 via the hardware of the processor configured for managing communications with the memory 200, such the memory management unit. In some examples, the memory 200 accessible through the secure operating system 216 may be a part of the memory 200 and/or a separate memory 200 accessible from the secure execution environment 212 and not accessible from the normal execution environment 202. The secure monitor 218 may be configured to control allowing communications between the normal execution environment 202 and the secure execution environment 212.

An application 204a-204d may be executed by the processor 200 using the normal execution environment 202 and may initialize a session with the secure execution environment 212, such as with a secure application 214a, 214b and/or the secure operating system 216. The application 204a-204d may provide the secure execution environment 212 with a cryptographic key, which may be used for encrypting data of the application 204a-204d in response to a potential unexpected read of the dedicated memory space of the application 204a-204d. The secure application 214a, 214b may be executed by the processor 200 using the secure execution environment 212 and may store the cryptographic key provided by the 204a-204d at the memory 200.

The application 204a-204d may periodically read the application's dedicated memory space. In some examples, the software executed by the normal execution environment 202, such as the rich operating system 202, the guest operating system 208, and/or the hypervisor 210, may enable the application 204a-204d to read the application's dedicated memory space and may track the access by setting a memory access flag associated with the application's dedicated memory space. The application 204a-204d may issue a call to clear the memory access flag, and the software of the normal execution environment 202 may respond to the call by clearing the memory access flag. A set memory access flag may be configured to indicate to the application 204a-204d and/or the software of the normal execution environment 202 that the application's dedicated memory space has been accessed since the memory access flag was last cleared. A not set (cleared) memory access flag may be configured to indicate to the application 204a-204d and/or the software of the normal execution environment 202 that the application's dedicated memory space has not been accessed since the memory access flag was last cleared.

The application and/or the software of the normal execution environment 202 may periodically, episodically, randomly, etc. check the memory access flag and determine whether the memory access flag is set. In some examples, the periodicity of when the memory access flag is checked may be such that the check is implemented sufficiently frequently to thwart usefulness of the data from the application's dedicated memory space to a malicious actor. For example, for a game application, data from the application's dedicated memory space may change nearly constantly, and the periodicity of when the memory access flag is checked may be as frequent as the periodicity for the application 204a-204d to read the application's dedicated memory space. The check of the memory access flag may be configured to occur a wait duration following an access duration for the application 204a-204d to read the application's dedicated memory space, and/or a wait duration preceding the access duration for the application 204a-204d to read the application's dedicated memory space. As another example, the check of the memory access flag may be configured to occur independent of timing of an access duration. The check of the memory access flag may be configured to occur a wait duration following a prior check of the memory access flag.

In response to determining that the memory access flag is set, the application 204a-204d may issue a call to the secure execution environment 212, such to the secure application 214a, 214b, to encrypt a copy of the data of the application's dedicated memory space. The call issued by the application 204a, 204d may include an address to the data of the application's dedicated memory space and/or may include the data of the application's dedicated memory space. The data of the application's dedicated memory space may include a state of the memory access flag for the application's dedicated memory space. The secure application 214a, 214b may generate an encrypted copy of the data of the application's dedicated memory space. A copy of the data of the application's dedicated memory space may be encrypted using the cryptographic key stored by the secure application 214a, 214b at the memory 200. The encrypted data may include other data, such as a timestamp, user information, computing device information, expected memory access state, etc. The secure application 214a, 214b may send the encrypted copy of the data at the application's dedicated memory space to a remote server.

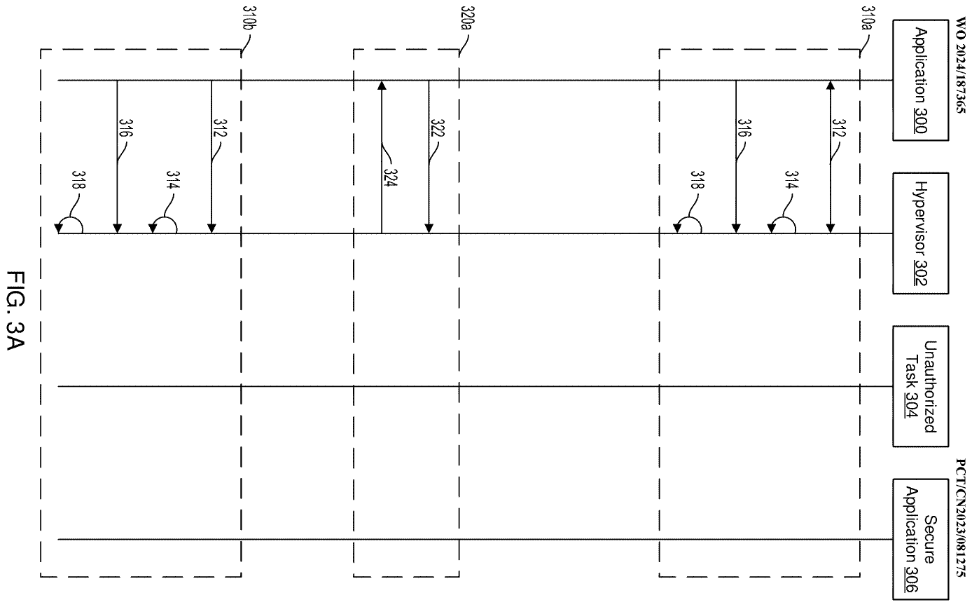

FIGS. 3A and 3B illustrate an example of detecting unexpected memory read for implementing various embodiments. With reference to FIGS. 1-3B, a processor (e.g., processor 14 in FIG. 1, processor 200 in FIG. 2) may be configured with processor-executable instructions for implementing an application 300 (e.g., application 204c, 204d in FIG. 2), a hypervisor 302 (e.g., hypervisor 210 in FIG. 2), and an unauthorized task 304 in a normal execution environment (e.g., normal execution environment 202 in FIG. 2). The processor may be configured with processor-executable instructions for implementing a secure application 306 (e.g., secure application 214a, 214b in FIG. 2) in a secure execution environment (e.g., secure execution environment 212 in FIG. 2).

FIG. 3A illustrates an example in which no unexpected memory read is detected. During an access duration 310a, 310b the application 300 may access a memory space dedicated for use by the application 300 in a memory (e.g., memory 16, 36 in FIG. 1, memory 200 in FIG. 2). Access durations 310a, 310b may occur periodically for the application 300. The following descriptions of the access duration 310a may be similarly applied to a successive access duration 310b. The application 300 may be configured to access the application's dedicated memory during the access duration 310a, rather than at any time outside of the access duration 310a. The application 300 may issue a memory access request for the application's dedicated memory and receive a return of the memory access request (operation 312) via the hypervisor 302. The memory access request may include a virtual address of the application's dedicated memory space.

The hypervisor 302 and/or a memory management unit (not shown in FIG. 3A but such as memory interface 34 in FIG. 1) may use one or more page tables to translate the virtual address of the application's dedicated memory space to a physical address of the memory to implement the memory access request and return of the memory access request. The hypervisor 302 and/or the memory management unit may set a memory access flag (operation 314) in the one or more page tables for one or more memory locations associated with the application's dedicated memory space. For example, the one or more page tables may be stored in a memory (e.g., memory 16, 36 in FIG. 1, memory 200 in FIG. 2) and locations in the memory may store address translation data and associated memory access flag data. As another example, the one or more page tables may be a stage 2 page table and the memory access flag may be associated with a stage 2 page table translation for the virtual address associated with the application's dedicated memory space. Setting the memory access flag may include storing a designated data value to the location of the memory for the memory access flag. The set memory access flag may be configured to indicate to the application 300 that the application's dedicated memory space has been accessed since the memory access flag was last cleared.

The application 300, after issuing the memory access request for the application's dedicated memory (operation 312), may issue a call to clear the memory access flag (operation 316). The call to clear the memory access flag may be sent to the hypervisor 302. The hypervisor 302 may clear the memory access flag (operation 318) in the one or more page tables for the one or more memory locations associated with the application's dedicated memory space. Clearing the memory access flag may include storing a designated data value to the location of the memory for the memory access flag. The not set (cleared) memory access flag may be configured to indicate to the application 300 that the application's dedicated memory space has not been accessed since the memory access flag was last cleared.

At least issuing the memory access request for the application's dedicated memory (operation 312) may be implemented in the access duration 310a. In some examples, any combination of the setting the memory access flag (operation 314), issuing the call to clear the memory access flag (operation 316), and clearing the memory access flag (operation 318) may occur in the access duration 310a or in close succession to the access duration 310a. Close succession may be a duration in which it may be substantially unlikely that the unauthorized task 304 may implement.

During a check duration 320a, the application 300 may issue a request for the state of the memory access flag (operation 322). The request for the state of the memory access flag may be issued to the hypervisor 302, which may return the state of the memory access flag (operation 324) to the application 300. The state of the memory access flag may indicate to the application 300 whether the memory access flag is set or not set. The set memory access flag may indicate to the application 300 that the application's dedicated memory space was accessed since the memory access flag was last cleared. The application 300 may interpret the set memory access flag as a result of a potentially unexpected memory access to the application's dedicated memory space. The not set memory access flag may indicate to the application 300 that the application's dedicated memory space was not accessed since the memory access flag was last cleared. The application 300 may interpret the not set memory access flag as a result of no unexpected memory access to the application's dedicated memory space. In some examples, at least issuing the memory access request for the application's dedicated memory (operation 312) may be implemented in the access duration 310a. In the example illustrated in FIG. 3A, the hypervisor 302 may return a not set memory access flag state 300.

The check duration 320a may be a wait duration from the access duration 310a and/or a wait duration to a successive access duration 310b. For example, the check duration 320a occur a wait duration from the access duration 310a and/or a wait duration to a successive access duration 310b for which it may be substantially unlikely that the unauthorized task 304 may implement between the check duration and the successive access duration 310b. As another example, the check duration 320a may occur a wait duration from a prior check duration 320a, independent of the timing of the access duration 310a, 310b. As another example, the check duration 320a may at least overlap with an access duration 310a, 310b. At least issuing the request for the state of the memory access flag (operation 322) may be implemented in the check duration 320a. In some examples, returning the state of the memory access flag (operation 324) may occur in the check duration 320a or successively to, such as in close succession, to the check duration 320a. Close succession may be a duration in which it may be substantially unlikely that the unauthorized task 304 may implement.

FIG. 3B illustrates an example in which a potentially unexpected memory read is detected. The access durations 310a, 310b and the operations 322, 324, 326, 328 may be implemented as described herein with reference to FIG. 3A. A malevolent actor may have inserted processor-executable instructions of the unauthorized task 304 having access privileges to the application's dedicated memory space. The processor may implement the processor-executable instructions of the unauthorized task 304, including issuing a memory access request for the application's dedicated memory (operation 330) via the hypervisor 302. The memory access request may include a virtual address of the application's dedicated memory space. In some examples, the processor may implement the unauthorized task 304 between the access duration 310a and a check duration 320b. In some examples, the processor may implement the unauthorized task 304 between clearing the memory access flag (operation 318) and issuing the request for the state of the memory access flag (operation 322).

The hypervisor 302 and/or a memory management unit (not shown in FIG. 3B but such as memory interface 34 in FIG. 1) may use the one or more page tables to translate the virtual address of the application's dedicated memory space to a physical address of the memory to implement the memory access request. The hypervisor 302 and/or the memory management unit may set the memory access flag (operation 332) in the one or more page tables for one or more memory locations associated with the application's dedicated memory space. For example, the one or more page tables may be stored in a memory (e.g., memory 16, 36 in FIG. 1, memory 200 in FIG. 2) and locations in the memory may store address translation data and associated memory access flag data. As another example, the one or more page tables may be a stage 2 page table and the memory access flag may be associated with a stage 2 page table translation for the virtual address associated with the application's dedicated memory space. Setting the memory access flag may include storing a designated data value to the location of the memory for the memory access flag. The set memory access flag may be configured to indicate to the application 300 that the application's dedicated memory space has been accessed since the memory access flag was last cleared.

The check duration 320b and the operations 322, 324 may be implemented as described herein for check duration 320a with reference to FIG. 3A. In the example illustrated in FIG. 3B, the hypervisor 302 may return a set memory access flag state to the application 300. The example illustrated in FIG. 3B may further include that in response to receiving the set memory access flag state, the application 300 may issue a call to encrypt a copy of the application's dedicated memory space (operation 326) to the secure application 306. The call to encrypt a copy of the application's dedicated memory space may include the location of the application's dedicated memory space and/or the data of the application's dedicated memory space.

In response to the call to encrypt a copy of the data of the application's dedicated memory space, the secure application 306 may encrypt a copy of the data of the application's dedicated memory space (operation 328). In some examples, the secure application 306 may encrypt the data of the application's dedicated memory space provided with the call to encrypt a copy of the data of the application's dedicated memory space. In some examples, the secure application 306 may retrieve the data of the application's dedicated memory space from the application's dedicated memory space and encrypt the retrieved data. The data of the application's dedicated memory space may include the state of the memory access flag for the application's dedicated memory space. To encrypt the copy of the data of the application's dedicated memory space, the secure application 306 may retrieve a cryptographic key from a memory (e.g., memory 16, 36 in FIG. 1, memory 200 in FIG. 2) and use the key in an encryption process. In some examples, the cryptographic key may be provided by the application 300, such as part of a session established between the application 300 and the secure application 306. In some examples, the cryptographic key may be preconfigured for the secure application 306. The encrypted data may include other data, such as a timestamp, user information, computing device information, expected memory access state, etc.

At least issuing the request for the state of the memory access flag (operation 322) may be implemented in the check duration 320b. In some examples, any combination of returning the state of the memory access flag (operation 324), calling to encrypt a copy of the application's dedicated memory space (operation 326), and/or encrypting a copy of the application's dedicated memory space (operation 328) may occur in the check duration 320b or successively to, such as in close succession to, the check duration 320b. Close succession may be a duration in which it may be substantially unlikely that the unauthorized task 304 may implement.

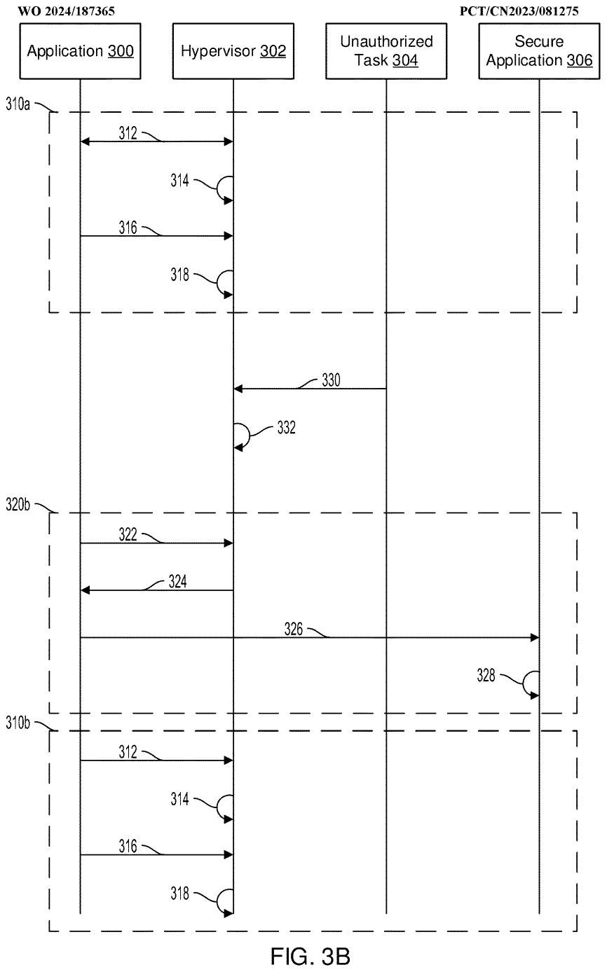

FIG. 4 illustrates a method of detecting unexpected memory read according to some embodiments. With reference to FIGS. 1-4, the method 400 may be implemented in a computing device (e.g., computing device 10 in FIG. 1), in software executing in a processor (e.g., processor 14 in FIG. 1, processor 200 in FIG. 2), in general purpose hardware, in dedicated hardware, or in a combination of a software-configured processor and dedicated hardware, such as a processor executing software within a system that includes other individual components, and various memory/cache controllers (e.g., memory interface 34 in FIG. 1). In order to encompass the alternative configurations enabled in various embodiments, the hardware implementing the method 400 is referred to herein as an “processing device.”

In block 402, the processing device may set a memory access flag. An application (e.g., application 204a-204d in FIG. 2, application 300 in FIGS. 3A and 3B) may issue a memory access request to a memory space dedicated to the application. The processing device may receive the memory access request from the application for the application's dedicated memory space. The processing device may facilitate implementation of the memory access request by translating a virtual address to the application's dedicated memory space of the memory access request to a physical address of a memory (e.g., memory 16, 36 in FIG. 1, memory 200 in FIG. 2) corresponding to the application's dedicated memory space.

The memory translation may use one or more page tables. The processing device may set the memory access flag in the one or more page tables for one or more memory locations associated with the application's dedicated memory space. For example, the one or more page tables may be stored in a memory (e.g., memory 16, 36 in FIG. 1, memory 200 in FIG. 2) and locations in the memory may store address translation data and associated memory access flag data. As another example, the one or more page tables may be a stage 2 page table and the memory access flag may be associated with a stage 2 page table translation for the virtual address associated with the application's dedicated memory space. Setting the memory access flag may include storing a designated data value to the location of the memory for the memory access flag. The set memory access flag may be configured to indicate to the processing device, such as to the application executed by the processing device, that the application's dedicated memory space has been accessed since the memory access flag was last cleared. In some embodiments, the processing device setting the memory access flag in block 402 may be a processor (e.g., processor 14 in FIG. 1, processor 200 in FIG. 2), and the processor may be executing a hypervisor (e.g., hypervisor 210 in FIG. 2, hypervisor 302 in FIGS. 3A and 3B), and/or may be a memory management unit (e.g., memory interface 34 in FIG. 1).

In block 404, the processing device may receive a call to clear the memory access flag. The application executed by the processing device may issue the call to clear the memory access flag following issuing the memory access request. The processing device may receive the call to clear the memory access flag from the application. In some examples, the processing device may receive the call to clear the memory access flag during an access duration configured for the application to access the application's dedicated memory. In some examples, the processing device may receive the call to clear the memory access flag following the access duration and within a period in which it is substantially unlikely for an unauthorized task (e.g., unauthorized task 304 in FIGS. 3A and 3B) to request to access the application's dedicated memory space. In some embodiments, the processing device receiving the call to clear the memory access flag in block 404 may be the processor, and the processor may be executing the hypervisor.

In block 406, the processing device may clear the memory access flag. In response to the call to clear the memory access flag, the processing device may clear the memory access flag. The processing device may clear the memory access flag in the one or more page tables for the one or more memory locations associated with the application's dedicated memory space. For example, the processing device may clear the memory access flag associated with the memory locations of the application's dedicated memory space in the stage 2 page table. Clearing the memory access flag may include storing a designated data value to the location of the memory for the memory access flag. The not set (cleared) memory access flag may be configured to the processing device, such as to the application executed by the processing device, that the application's dedicated memory space has not been accessed since the memory access flag was last cleared. In some examples, the processing device may clear the memory access flag during the access duration. In some examples, the processing device may clear the memory access flag following the access duration and within the period in which it is substantially unlikely for the unauthorized task to request to access the application's dedicated memory space. In some embodiments, the processing device clearing the memory access flag in block 406 may be the processor, and the processor may be executing the hypervisor.

In optional block 408, the processing device may set the memory access flag. The processing device may respond to a memory access request for the application's dedicated memory space, in part, by setting the memory access flag for the application's dedicated memory space. The processor may not discriminate the source of the memory access request to the application's dedicated memory space. In some examples, the unauthorized may issue a memory access request for the application's dedicated memory space, and the processing device may respond by setting the memory access flag associated with the application's dedicated memory access space in a similar manner as described for block 402. For example, the processing device may set the memory access flag associated with the memory locations of the application's dedicated memory space in the stage 2 page table. The set memory access flag may be configured to indicate to the processing device, such as to the application executed by the processing device, that the application's dedicated memory space has been accessed since the memory access flag was last cleared. In some examples, optional block 408 may not be implemented when no memory access request is received for the application's dedicated memory space. In some examples, the processing device setting the memory access flag in optional block 408 may be the processor, and the processor may be executing the hypervisor, and/or may be the memory management unit.

In determination block 410, the processing device may determine whether the access flag is set. The processing device may retrieve a state of the memory access flag. For example, the processing device may retrieve the state of the memory access flag associated with the memory locations of the application's dedicated memory space in the stage 2 page table.

The state of the memory access flag may indicate to the processing device whether the memory access flag is set or not set. The set memory access flag may indicate to the processing device that the application's dedicated memory space was accessed since the memory access flag was last cleared. The processing device may interpret the set memory access flag as a result of a potentially unexpected memory access to the application's dedicated memory space. The not set memory access flag may indicate to the processing device that the application's dedicated memory space was not accessed since the memory access flag was last cleared. The processing device may interpret the not set memory access flag as a result of no unexpected memory access to the application's dedicated memory space.

In some examples, determining whether the access flag is set may be implemented during a check duration configured for the application to check the state of the memory access flag associated with the application's dedicated memory. In some examples, determining whether the access flag is set may be implemented following the check duration and within the period in which it is substantially unlikely for the unauthorized task to request to access the application's dedicated memory space. In some embodiments, the processing device determining whether the access flag is set in determination block 410 may be the processor, and the processor may be executing the application and/or the hypervisor, and/or may be the memory management unit.

In response to determining that the memory access flag is not set (i.e., determination block 410=“No”), the processing device may set a memory access flag in block 402. In some embodiments, the processing device setting the memory access flag in block 402 may be the processor, and the processor may be executing the hypervisor, and/or may be the memory management unit.

In response to determining that the memory access flag is set (i.e., determination block 410=“Yes”), the processing device may generate an encrypted copy of the data of the application's dedicated memory space in block 412. The processing device may receive a call from the application to generate the encrypted copy of the data of the application's dedicated memory space. The call may include an address to the data of the application's dedicated memory space and/or the data of the application's dedicated memory space. The data of the application's dedicated memory space may include the state of the memory access flag for the application's dedicated memory space. The processing device may retrieve a cryptographic key from the memory used to generate the encrypted copy of the data at the application's dedicated memory space. The cryptographic key may be preconfigured and/or provided to the processing device by the application, for example, during setup of a session between the application and a secure application (e.g., secure application 214a, 214b in FIG. 2, secure application 308 in FIGS. 3A and 3B). The processing device may generate the encrypted copy of the data of the application's dedicated memory space using the retrieved cryptographic key. The encrypted data may include other data, such as a timestamp, user information, computing device information, expected memory access state, etc. In some embodiments, the processing device generating the encrypted copy of the data at the application's dedicated memory space in block 412 may be the processor, and the processor may be executing the secure application.

In block 414, the processing device may send the encrypted copy of the data at the application's dedicated memory space to a remote server. The processing device may send the encrypted copy of the data at the application's dedicated memory space for evaluation by the remote server as to whether the potentially unexpected memory read was implemented by a malicious actor. In some embodiments, the processing device sending the encrypted copy of the data at the application's dedicated memory space to a remote server in block 414 may be the processing device, and the processing device may be executing the secure application.

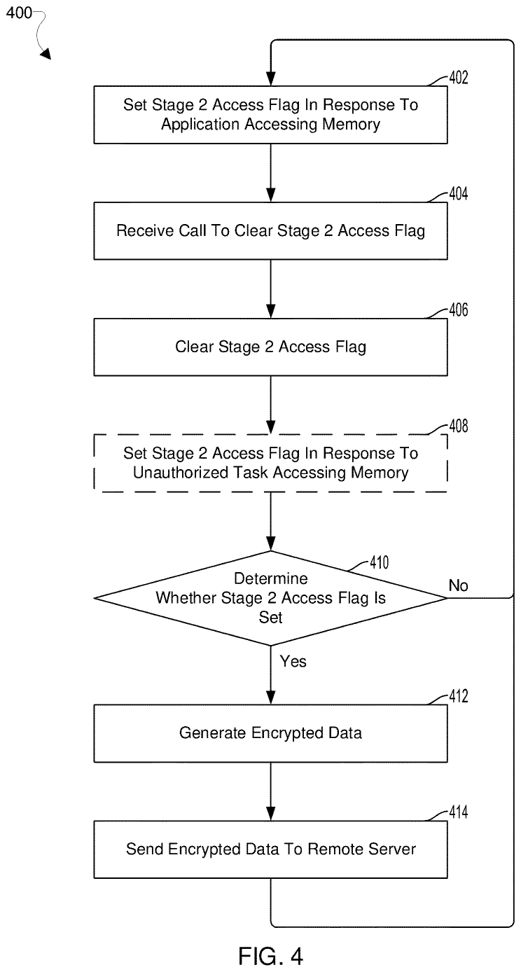

Various embodiments (including, but not limited to, embodiments described above with reference to FIGS. 1-4) may be implemented in a wide variety of computing systems including mobile computing devices, an example of which suitable for use with the various embodiments is illustrated in FIG. 5. The mobile computing device 500 may include a processor 502 coupled to a touchscreen controller 504 and an internal memory 506. The processor 502 may be one or more multicore integrated circuits designated for general or specific processing tasks. The internal memory 506 may be volatile or non-volatile memory and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, embedded DRAM, non-volatile flash memory, UFS, SDCC, etc. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the mobile computing device 500 need not have touch screen capability.

The mobile computing device 500 may have one or more radio signal transceivers 508 (e.g., Peanut, Bluetooth, ZigBee, Wi-Fi, RF radio) and antennae 510, for sending and receiving communications, coupled to each other and/or to the processor 502. The transceivers 508 and antennae 510 may be used with the above-mentioned circuitry to implement the various wireless transmission protocol stacks and interfaces. The mobile computing device 500 may include a cellular network wireless modem chip 516 that enables communication via a cellular network and is coupled to the processor 502.

The mobile computing device 500 may include a peripheral device connection interface 518 coupled to the processor 502. The peripheral device connection interface 518 may be singularly configured to accept one type of connection or may be configured to accept various types of physical and communication connections, common or proprietary, such as Universal Serial Bus (USB), Fire Wire, Thunderbolt, or PCIe. The peripheral device connection interface 518 may also be coupled to a similarly configured peripheral device connection port (not shown).

The mobile computing device 500 may also include speakers 514 for providing audio outputs. The mobile computing device 500 may also include a housing 520, constructed of a plastic, metal, or a combination of materials, for containing all or some of the components described herein. The mobile computing device 500 may include a power source 522 coupled to the processor 502, such as a disposable or rechargeable battery. The rechargeable battery may also be coupled to the peripheral device connection port to receive a charging current from a source external to the mobile computing device 500. The mobile computing device 500 may also include a physical button 524 for receiving user inputs. The mobile computing device 500 may also include a power button 526 for turning the mobile computing device 500 on and off.

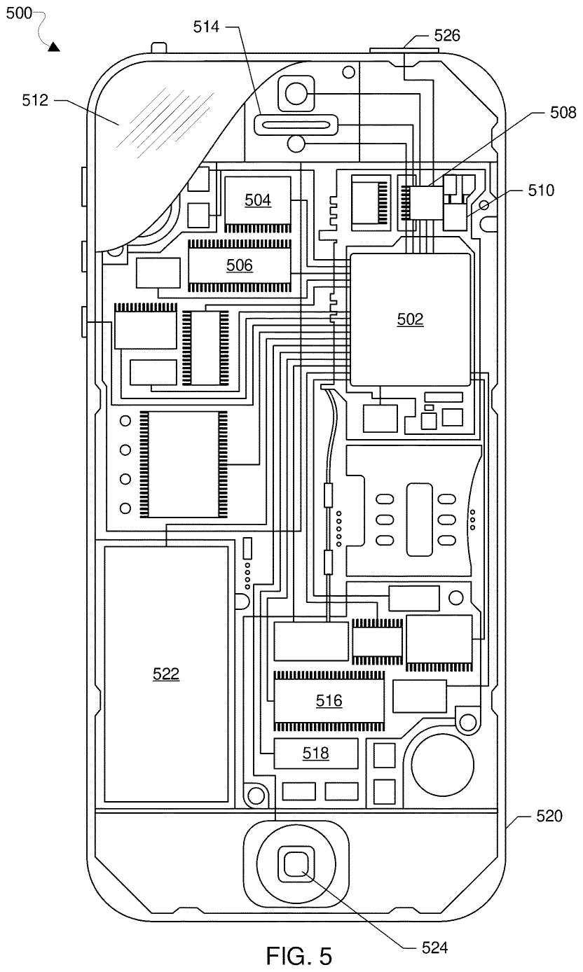

The various embodiments (including, but not limited to, embodiments described above with reference to FIGS. 1-4) may be implemented in a wide variety of computing systems including a laptop computer 600, an example of which is illustrated in FIG. 6. Many laptop computers include a touchpad touch surface 617 that serves as the computer's pointing device, and thus may receive drag, scroll, and flick gestures similar to those implemented on computing devices equipped with a touch screen display and described above. A laptop computer 600 will typically include a processor 602 coupled to volatile memory 612 and a large capacity nonvolatile memory, such as a disk drive 613 of Flash memory. Additionally, the computer 600 may have one or more antenna 608 for sending and receiving electromagnetic radiation that may be connected to a wireless data link and/or cellular telephone transceiver 616 coupled to the processor 602. The computer 600 may also include a floppy disc drive 614 and a compact disc (CD) drive 615 coupled to the processor 602. In a notebook configuration, the computer housing includes the touchpad 617, the keyboard 618, and the display 619 all coupled to the processor 602. Other configurations of the computing device may include a computer mouse or trackball coupled to the processor 602 (e.g., via a USB input) as are well known, which may also be used in conjunction with the various embodiments.

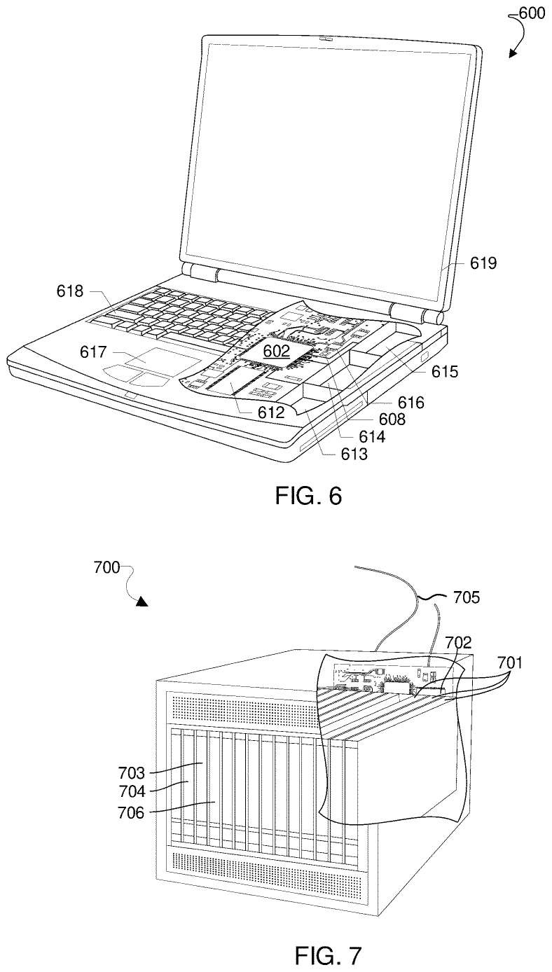

The various embodiments (including, but not limited to, embodiments described above with reference to FIGS. 1-4) may also be implemented in fixed computing systems, such as any of a variety of commercially available servers. An example server 700 is illustrated in FIG. 7. Such a server 700 typically includes one or more multicore processor assemblies 701 coupled to volatile memory 702 and a large capacity nonvolatile memory, such as a disk drive 704. As illustrated in FIG. 7, multicore processor assemblies 701 may be added to the server 700 by inserting them into the racks of the assembly. The server 700 may also include a floppy disc drive, compact disc (CD) or digital versatile disc (DVD) disc drive 706 coupled to the processor 701. The server 700 may also include network access ports 703 coupled to the multicore processor assemblies 701 for establishing network interface connections with a network 705, such as a local area network coupled to other broadcast system computers and servers, the Internet, the public switched telephone network, and/or a cellular data network (e.g., CDMA, TDMA, GSM, PCS, 3G, 4G, 5G, LTE, or any other type of cellular data network).

Computer program code or “program code” for execution on a programmable processor for carrying out operations of the various embodiments may be written in a high-level programming language such as C, C++, C #, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Implementation examples are described in the following paragraphs. While some of the following implementation examples are described in terms of example systems, devices, or methods, further example implementations may include: the example systems or devices discussed in the following paragraphs implemented as a method executing operations of the example systems or devices, the example systems, devices, or methods discussed in the following paragraphs implemented by a processor configured to perform operations of the example systems, devices, or methods; the example systems, devices, or methods discussed in the following paragraphs implemented by a computing device comprising a processing device configured with processing device-executable instructions to perform operations of the example systems, devices, or methods; a computing device including means for performing functions of the example systems, devices, or methods; and the example systems, devices, or methods discussed in the following paragraphs implemented as a non-transitory processor-readable storage medium having stored thereon processor-executable instructions configured to cause a processor of a computing device to perform the operations of the example systems, devices, or methods.

Example 1. A method implemented in a processor of a computing device for detecting an unexpected memory read, including clearing a memory access flag following a first duration in which an application is configured for access to a memory of the computing device; and determining whether the memory access flag is set following clearing the memory access flag.

Example 2. The method of example 1, further including receiving a call to clear the memory access flag from the application following the first duration, in which clearing the memory access flag includes clearing the memory access flag in response to receiving the call to clear the memory access flag.

Example 3. The method of either of examples 1 or 2, further including setting the memory access flag in response to a memory access following clearing the memory access flag.

Example 4. The method of any of examples 1-3, in which determining whether the memory access flag is set following clearing the memory access flag includes determining whether the memory access flag is set during a second duration following the first duration.

Example 5. The method of any of examples 1-4, in which determining whether the memory access flag is set following clearing the memory access flag includes determining whether the memory access flag is set during a second duration preceding a successive first duration.

Example 6. The method of any of examples 1-5, further including generating encrypted data of the memory in response to determining that the memory access flag is set following clearing the memory access flag; and sending the encrypted data of the memory to a remote server.

Example 7. The method of example 6, in which generating encrypted data of the memory includes generating encrypted data of the memory at a secure execution environment of the processor using an encryption key provided by the application.

Example 8. The method of any of examples 1-7, in which the memory access flag is a stage 2 page table access flag.

The foregoing method descriptions and the process flow diagrams are provided merely as illustrative examples and are not intended to require or imply that the operations of the various embodiments must be performed in the order presented. The order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein but is to be accorded the widest scope consistent with the following claims and the principles and novel features disclosed herein.

1. A method implemented in a processor of a computing device for detecting an unexpected memory read, comprising:
clearing a memory access flag following a first duration in which an application is configured for access to a memory of the computing device; and
determining whether the memory access flag is set following clearing the memory access flag.

2. The method of claim 1, further comprising receiving a call to clear the memory access flag from the application following the first duration, wherein clearing the memory access flag comprises clearing the memory access flag in response to receiving the call to clear the memory access flag.

3. The method of claim 1, further comprising setting the memory access flag in response to a memory access following clearing the memory access flag.

4. The method of claim 1, wherein determining whether the memory access flag is set following clearing the memory access flag comprises determining whether the memory access flag is set during a second duration following the first duration.

5. The method of claim 1, wherein determining whether the memory access flag is set following clearing the memory access flag comprises determining whether the memory access flag is set during a second duration preceding a successive first duration.

6. The method of claim 1, further comprising:
generating encrypted data of the memory in response to determining that the memory access flag is set following clearing the memory access flag; and
sending the encrypted data of the memory to a remote server.

7. The method of claim 6, wherein generating encrypted data of the memory comprises generating encrypted data of the memory at a secure execution environment of the processor using an encryption key provided by the application.

8. (canceled)

9. A computing device, comprising:
a memory; and
a processor coupled to the memory and configured to:
clear a memory access flag following a first duration in which an application is configured for access to a memory of the computing device; and
determining whether the memory access flag is set following clearing the memory access flag.

10. The computing device of claim 9, wherein the processor is further configured to:
receive a call to clear the memory access flag from the application following the first duration; and
clear the memory access flag in response to receiving the call to clear the memory access flag.

11. The computing device of claim 9, wherein the processor is further configured to set the memory access flag in response to a memory access following clearing the memory access flag.

12. The computing device of claim 9, wherein the processor is further configured to determine whether the memory access flag is set during a second duration following the first duration.

13. The computing device of claim 9, wherein the processor is further configured to determine whether the memory access flag is set during a second duration preceding a successive first duration.

14. The computing device of claim 9, wherein the processor is further configured to:
generate encrypted data of the memory in response to determining that the memory access flag is set following clearing the memory access flag; and
send the encrypted data of the memory to a remote server.

15. The computing device of claim 14, wherein the processor is further configured to generate the encrypted data of the memory at a secure execution environment of the processor using an encryption key provided by the application.

16. (canceled)

17. A computing device, comprising:
means for clearing a memory access flag following a first duration in which an application is configured for access to a memory of the computing device; and
means for determining whether the memory access flag is set following clearing the memory access flag.

18. The computing of claim 17, further comprising means for receiving a call to clear the memory access flag from the application following the first duration, wherein means for clearing the memory access flag comprises means for clearing the memory access flag in response to receiving the call to clear the memory access flag.

19. The computing device of claim 17, further comprising means for setting the memory access flag in response to a memory access following clearing the memory access flag.

20. The computing device of claim 17, wherein means for determining whether the memory access flag is set following clearing the memory access flag comprises means for determining whether the memory access flag is set during a second duration following the first duration.

21. (canceled)

22. The computing device of claim 17, further comprising:
means for generating encrypted data of the memory in response to determining that the memory access flag is set following clearing the memory access flag; and
means for sending the encrypted data of the memory to a remote server.

23. The computing device of claim 22, wherein means for generating encrypted data of the memory comprises means for generating encrypted data of the memory at a secure execution environment using an encryption key provided by the application.

24-30. (canceled)
